(19) United States
(12) Patent Application Publication
(10) Pub. No.: US 2026/0065767 A1
(43) Pub. Date: Mar. 5, 2026

(54) UTILIZATION NOTIFICATIONS FOR WEARABLE DEVICES

(71) Applicant: T-MOBILE INNOVATIONS LLC, Overland Park, KS (US)

(72) Inventors: Maikel E. FALTAOUS, Renton, WA (US); Kristopher Michael MCNEIL, Sammamish, WA (US)

(21) Appl. No.: 18/824,815

(22) Filed: Sep. 4, 2024

(51) Int. Cl. G08B 21/18

(52) U.S. Cl. CPC G08B 21/18

(57) ABSTRACT

Embodiments of the present disclosure are directed to monitoring utilization of a user equipment (UE). Wearable UEs, typically having small form factors, are easily forgotten once removed. Using one or more sensors of the wearable UE, a non-use determination can be made that allows the wearable UE to notify a second, affiliated UE about its non-use. In some aspects, usage patterns or divergent usage of the wearable UE and affiliated UE are used to validate non-use determinations before causing a notification to be delivered on the affiliated UE.

### SUMMARY

The present disclosure is directed to providing notifications to a user when a wearable device is removed from an as-worn configuration, substantially as shown and/or described in connection with at least one of the Figures, and as set forth more completely in the claims.

According to various aspects of the technology, a notification is provided to a user equipment (UE) when a wearable UE is not in use. Though largely helpful or convenient, wearable UEs, such as smartwatches, fitness trackers, or medical devices can be frustratingly easy to misplace. Whether inadvertently left behind in the morning when leaving for work, or intentionally removed by a teenager that does not want to be tracked by his parents, it would be helpful to have a more intelligent paradigm for providing situational awareness of wearable UE non-use. One or more sensors, modules, or usage patterns may be used to determine that the wearable UE is not in use and then provide a non-use indication to another UE, whether associated with the user of the wearable UE or associated with a parent/guardian of the user.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2. illustrates a network environment in which implementations of the present disclosure may be employed;

FIG. 3. Illustrates an environment in which implementations of the present disclosure may be employed;

FIG. 4 depicts a flow diagram suitable for use with the present disclosure; and

FIG. 5 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, wearable UEs, such as smart watches, fitness/health trackers, life alert devices, medical devices, and other tracking devices often have small form factors that are susceptible to non-use. A user may simply forget to put on a wearable UE, such as a health tracker, before leaving their house to go to work. Often times, the user does not realize they left the wearable UE at home until they have begun their commute or arrived at work. Frustrations relating to non-use of wearable UEs can limit the usefulness of data obtained by the wearable UE or affect adoption of wearable technology. In other situations, wearable UEs are used by parents/guardians to track children or provide peace of mind in case of emergency; however, some users (e.g., children and elderly) may be more prone to take off wearable UEs and forget to put them back on, or they might remove the wearable UE intentionally to avoid being tracked.

Conventionally, wearable UEs have limited feature sets that relate to their non-use. Common non-use notifications tend to exclusively be based on a breaking of a previously-established connection between the wearable UE and a paired UE (e.g., a phone). For one, there are scenarios where both the wearable UE and the paired UE are not in use but still connected to one another; in other cases, it may be desirable to reduce the number of notifications on the paired UE (such as when the wearable is just out of range) or to ensure higher accuracy of non-use notifications.

Unlike conventional solutions, the present disclosure is directed to systems and methods that provide improved utilization management of wearable UEs. By using one or more sensors, location modules, and radio components, it may be determined that the wearable UE is not in use—i.e., not coupled to the body. Whether based just on the sensor data or a comparison to a usage pattern, a non-use indication may then be provided to another UE. In instances where the wearable UE is associated with a custodial user, such as a child, ward, or elderly person, the non-use indication will be provided to a parent/guardian/caretaker UE. In instances where the wearable UE is not associated with a custodial user, the non-use indication will be provided to a UE associated with the same user as the wearable UE. By providing higher accuracy notifications, use of the wearable UE is likely to increase and the customer experience will be improved.

Accordingly, a first aspect of the present disclosure is directed to a system for monitoring utilization of a custodial user equipment (UE). The system comprises one or more antenna elements configured to transmit and receive wireless communication signals with a station. The system further comprises one or more sensors. The system further comprises one or more computer processing components configured to determine, based at least on information from the one or more sensors, that the custodial UE is not coupled to a user in a subject time period, the custodial UE being associated with the user. The one or more computer processing components are further configured to determine that the custodial UE was coupled to the user prior to the subject time period. The one or more computer processing components are further configured to, based on said determinations, provide a non-use indication to a custodian UE, the custodian UE being different than the custodial UE.

A second aspect of the present disclosure is directed to a method for monitoring utilization of a custodial user equipment (UE). The method comprises determining, based on information from one or more sensors, that the custodial UE is not coupled to a custodial user during a second time period. The method further comprises determining, based on the information from the one or more sensors, that the custodial UE was coupled to the custodial user during a first time period prior to the second time period. The method further comprises, based on said determinations, communicating a non-use indication to a custodian UE.

Another aspect of the present disclosure is directed to a non-transitory computer readable media having instructions stored thereon that, when executed by one or more computer processing components, cause the one or more computer processing components to perform a method for monitoring utilization of a custodial user equipment (UE). The method comprises determining, based on information from one or more sensors, that the custodial UE is not coupled to a custodial user during a second time period. The method further comprises determining, based on the information from the one or more sensors, that the custodial UE was coupled to the custodial user during a first time period prior to the second time period. The method further comprises based on said determinations, communicating a non-use indication to a custodian UE.

Another aspect of the present disclosure is directed to a system for monitoring utilization of a wearable UE. The system comprises one or more antenna elements configured to transmit and receive wireless communication signals with a station. The system further comprises one or more sensors. The system further comprises one or more computer processing components configured to determine, using information from one or more sensors of the wearable UE, that the wearable UE is not coupled to a user's body. The one or more computer processing components are further configured to determine that one or more notification conditions have been met. The one or more computer processing components are further configured to provide a non-use indication to a second UE, the second UE being associated with the user.

Another aspect of the present disclosure is directed to a method for monitoring utilization of a wearable UE. The method comprises receiving an indication, via a radio access network, from a wearable UE that the wearable UE is not coupled to a user's body. The method further comprises identifying a subscriber associated with the wearable UE. The method further comprises identifying a second UE associated with the subscriber. The method further comprises providing a non-use indication to a second UE, via the radio access network, the second UE being associated with the user.

Another aspect of the present disclosure is directed to a method for monitoring utilization of a wearable UE. The method comprises receiving, at a second UE associated with a user, a non-use message from a radio access network, the non-use message indicating that the wearable UE is not coupled to the user's body, the wearable UE being associated with the user. The method further comprises determining that one or more notification conditions have been met. The method further comprises outputting a notification on one or more interfaces of the second UE, the notification comprising one or more of displaying a visual element on a graphic user interface of the second UE, outputting an audible tone by the second UE, and operating a flashlight feature of the second UE

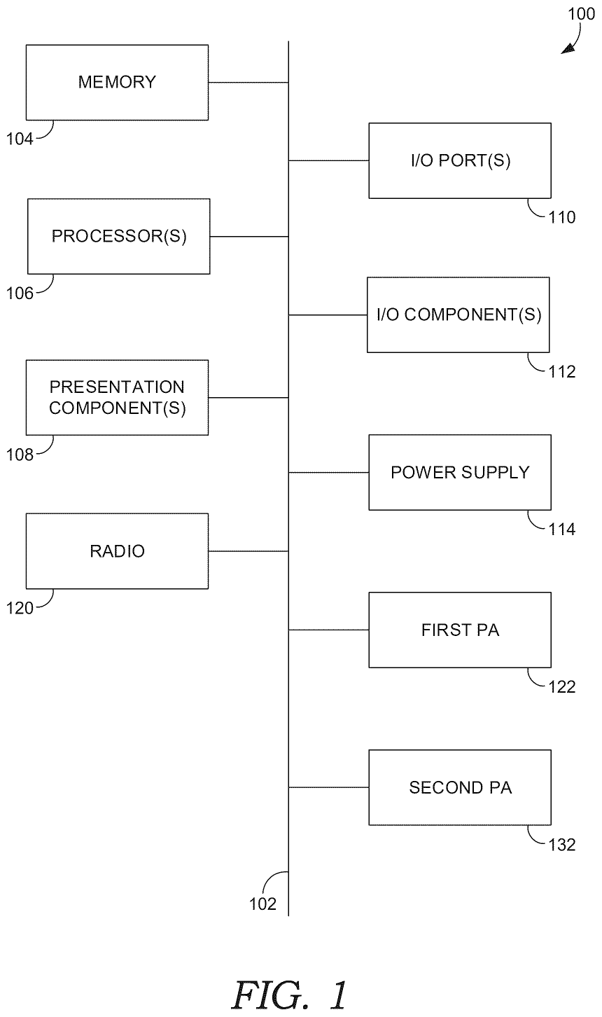

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

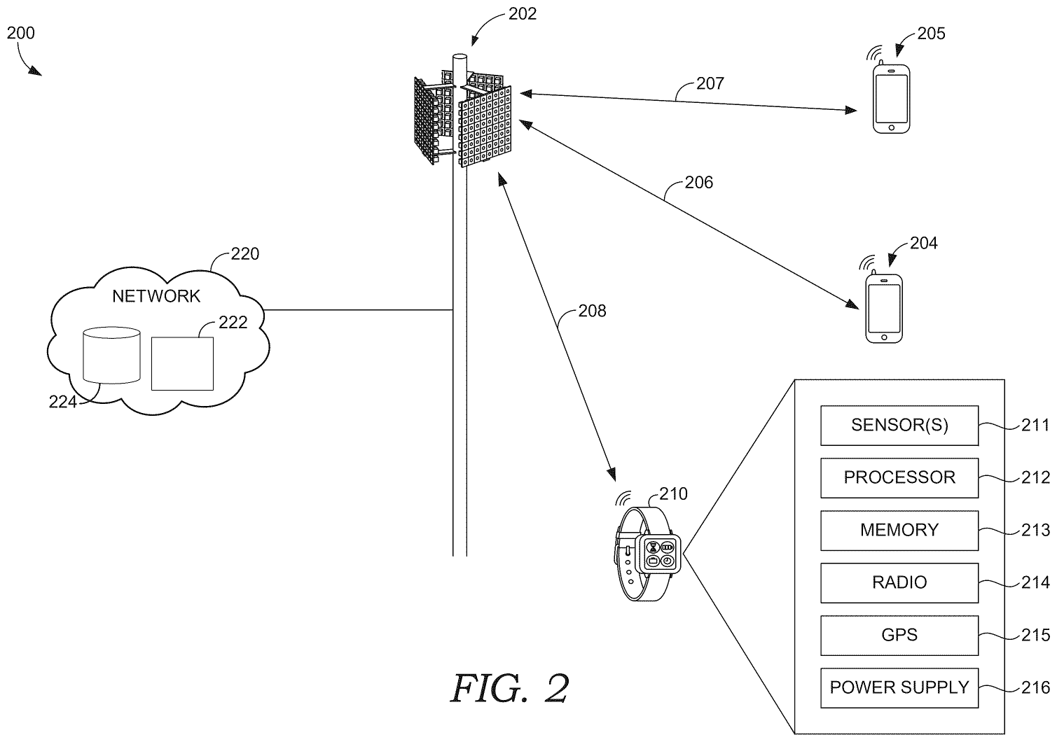

Turning now to FIG. 2, an exemplary network environment is illustrated in which implementations of the present disclosure may be employed. Such a network environment is illustrated and designated generally as network environment 200. At a high level the network environment 200 comprises one or more UEs, including one or more wearable UEs, one or more base stations, and one or more networks.

The network environment 200 comprises one or more base stations with which a UE may wirelessly communicate. Though a base station 202 is illustrated as a macro cell on a cell tower, any scale or form of access point acting as a transceiver station for wirelessly communicating with a UE, including small cells, pico cells, and the like, are suitable for use with the present disclosure. Additionally or alternatively, a base station consistent for use with the present disclosure may be an 802.11-based router, such as routers used in typical homes and businesses. The base station 202 comprises hardware and software components that allow it to wirelessly communicate with one or more UEs in one or more coverage areas. Each coverage area may be logically defined in space and frequency as one or more cells, which may or may not overlap. The base station 202 is configured to wirelessly communicate with a first UE 204 using a first wireless connection 206. The base station 202 is configured to wirelessly communicate with a wearable UE 210 using a second wireless connection 208. The base station 202 is configured to wirelessly communicate with a second UE 205 using a third wireless connection 207. The present disclosure is agnostic to a particular radio access technology (RAT); accordingly, many different RATs, such as 4G, 5G, 6G, 802.11/Wi-Fi, Bluetooth, NFC, LoRa, and any other protocol suitable for wirelessly transporting data are suitable for use with the present disclosure.

Each base station of the one or more base stations may be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

The network environment 200 comprises a network 220. The network 220 includes a cloud-based platform 222 and a database 224. In aspects, the network 200 is a telecommunications network having a plurality of access points that provide service to a plurality of user devices, such as wearable UE 210 and the first UE 204. The cloud-based platform 222 and the database 224 operate within the network 220, and as further discussed, can provide services to users via the wearable UE 210 and one or more of the first UE 204 and the second UE 205. The cloud-based platform 222 may be a virtual server that operates in a cloud computing environment, and which is supported by individual server(s) in data centers. Although a cloud-based platform 222 is discussed herein, it will be understood that platforms which are partially cloud-based or are not cloud-based may be utilized and leveraged, whether alone or in connection with a cloud-based server to perform aspects discussed herein. The database 224 can operate as cloud-based storage that supports the cloud-based platform 222 in a cloud computing environment as shown, or it may instead be partially cloud-based or not cloud-based, in various aspects.

The network environment 200 comprises one or more UEs other than the wearable UE 210. Though each of the first UE 204 and the second UE 205 are illustrated as cellular phones, a UE suitable for implementations with the present disclosure may be any computing device having any one or more aspects described with respect to FIG. 1, including, without limitation, a cell phone, a vehicle or vehicle infotainment display, a tracking device, and the like. In some aspects of the present disclosure, the first UE 204 and the second UE 205 may take different forms; for example, the first UE 204 may be a cell phone or a connected vehicle and the second UE 205 may be a tracking device. Each of the first UE 204 and the second UE 205 are configured to wirelessly communicate with one or more stations, such as the base station 202. In aspects, each of the first wireless connection 206, the second wireless connection 207, and a third wireless connection 208 between the wearable UE 210 and a station such as the base station 202 may utilize the same protocol (e.g., all three connections are 4G or 5G connections, or all three connections are 802.11-based connections), in other aspects, the three connections may utilize at least partially different protocols (e.g., the first wireless connection 206 and the second wireless connection 207 may use a 4G/5G connection and the third wireless connection 208 may be a 802.11-based connection). Though illustrated as communicating with the base station 202, it is expressly conceived that each of the first UE 204, the second UE 205, and the wearable UE 210 may communicate with different stations (e.g., each of the first UE 204 and the second UE 205 communicate with the base station 202 and the wearable UE 210 communicates with a Wi-Fi access point); one or more of said UEs may also be configured to communicate with another of said UEs (e.g., each of the first UE 204 and the second UE 205 communicate with the base station 202 and the wearable UE 210 communicates with the first UE 204). One skilled in the art will appreciate that many different combinations of the wireless connections described above are possible without departing from the present disclosure.

The network environment 200 comprises the wearable UE 210. The wearable 210 may be configured to be worn on the body of a wearer and detect or determine one or more physical or physiological conditions of the wearer. Though illustrated as a watch, the wearable UE 210 may take the form of a smart watch, fitness tracker, heart rate monitor, step counter, or health alert device. In other aspects, the wearable UE 210 may be a device that is configured to be carried with, if not necessarily worn on, the body of a user; for example, the wearable UE 210 may take the form of a tracking device. The wearable UE 210 comprises one or more sensors 211, a processor 212, a memory 213, a radio 214, a location service module such as a global positioning system 215, and a power supply 216. The sensor(s) 211 may include one or more sensors of the same or different kinds, such as a gyroscope (e.g., for detecting orientation of the wearable UE 210), an accelerometer (e.g., for detecting and measuring movement of the wearable UE 210), an optical sensor (e.g., for detecting and measuring light), a microphone, a temperature sensor, an atmospheric pressure sensor, a humidity or water sensor, a camera, a biometric sensor (e.g., heart rate sensor, blood pressure sensor, blood oxygenation sensor, capacitance sensor), and the like, and/or any combination thereof. The processor 212 may be a microcontroller unit and/or a microprocessor unit configured to operate and control hardware components of the wearable UE 210, in various aspects. The memory 213 may be physical memory for storing data and computer-readable instructions for execution and implementation via the processor 212, and/or any other components of the wearable UE 210. The radio 214 may be configured to send and receive wireless communications using multiple modalities, connections, and/or networks, concurrently or non-concurrently, including cellular telecommunications (e.g., 4G, 5G, 6G, etc.), Wi-Fi, short-range wireless (e.g., Bluetooth®), Near Field Communication (NFC), LoRa, or any other RF frequency/band that may be desirable (e.g., unlicensed spectrum, family radio service, general mobile radio service, amateur radio service, etc.), and the like using one or more antennas. The location service module, shown as the global positioning system 215, is a hardware component that utilizes measurements to determine the location, direction of travel, and/or speed (e.g., velocity) of travel of the wearable UE 210 in real-time or near real-time using a satellite network (not shown). The power supply 216 stores and provides energy to the wearable UE 210 and its components; the power supply 216 will typically be an internal battery, but external power supply may also be used with the wearable UE 210. In aspects where the wearable UE 210 is a tracker, the wearable UE 210 may not comprise a sensor in order to reduce size form and reduce complexity.

In various aspects, the wearable UE 210 includes additional features and components, such as a speaker, a light or light-emitting diode, a microphone, a modem, a low dropout regulator (LDO), and/or the like. In some aspects, the wearable UE 210 may be configured to initiate and receive voice calls, send and receive messages (e.g., short message service (SMS), rich communication service (RCS) messaging, and the like), and provide tracking service to associated devices. The wearable UE 210 may be paired with the first UE 204, and both the wearable UE 210 and the first UE 204 may be associated with the same subscriber or user. Additionally, the second UE 205 may be considered an associated or registered device vis-à-vis the wearable UE 210, allowing the second UE 205 to receive location and/or usage information of the wearable 210. In other aspects, the wearable UE 210 may be limited to making voice calls and messaging pre-approved devices—such as the second UE 205. In embodiments, both the wearable 210 and first UE 204 may belong to (and be used by) a minor child or ward and the second UE 205 may be registered to the child's parent or the ward's guardian.

It should also be understood that the network environment 200 is only one example of a suitable network environment, and this example has been simplified for ease of discussion. Accordingly, other components not shown may also be included within the environment, and one or more of the shown component may be omitted, in various embodiments. Each of the components may be implemented using any type or number. The components may communicate with each other directly or, for example, indirectly via a network, including one or more of a telecommunication network, a local area network (LANs), a wide area network (WANs), and/or a peer-to-peer-network. Such networking environments may include residential, campus-wide, or enterprise-wide computer networks, intranets, and the Internet. It should be understood that any number of components may be employed within the network environment 200 within the scope of the present invention. Each may be implemented via a single device or multiple devices cooperating in a distributed environment.

Embodiments of the present disclosure are used to provide indications about their non-use. Non-use may be inadvertent, intentional, or some combination thereof; in examples where the wearable UE 210 is in the form of a watch, the wearable UE 210 may be inadvertently left at home by an under-caffeinated patent attorney leaving for work, the wearable UE 210 may be taken off at school while a teenager sneaks out to a friend's house, or the wearable UE 210 may be intentionally removed for swim practice and then forgotten on a bench or in a locker room. In each example, it would be helpful to various parties to receive an indication about the non-use of the wearable UE 210. In a first embodiment, the wearable UE 210 is configured to provide a non-use indication based on a determination that it has been doffed (i.e., it was worn during a first time period and then removed from the body of its wearer and remained unworn during a second, subsequent time period). In a second embodiment, the wearable UE 210 is configured to provide a non-use indication based on a determination that it has been inadvertently left behind by its wearer. In a third, hybrid embodiment, the wearable UE 210 is configured to provide a non-use indication based on a determination that it has been doffed and subsequently left behind by its wearer.

In order to provide appropriate non-use indications, the wearable UE 210 is configured to determine that it is not in use or that it is not being worn. One or more different mechanisms may be used, whether alone or in any of numerous different combinations, as a basis for said non-use determination, including through the use of one or more sensors 211, a connection or connection parameter via the radio 214, location information using the location module 215, or power supply 216. The non-use determinations described herein may be absolute; the wearable UE 210 may focus on the binary state of whether it is in use (i.e., whether it donned or doffed). The non-use determinations described herein may, alternatively, be relative; the wearable UE 210 may be configured to make non-use determinations based on a state change from donned to doffed (e.g., low capacitance associated with non-use may not be sufficient for making a non-use determination unless higher capacitance associate with use was observed/determined for a threshold amount of time prior to the state change).

Information from one or more sensors 211 may be used to determine if the wearable UE 210 is not being used. If the sensor 211 comprises a capacitance sensor, then the wearable UE 210 may make a non-use determination based on a decrease in measured capacitance. If the sensor 211 comprises a heart rate or other biometric monitor (e.g., blood oxygen), then the wearable UE 210 may make a non-use determination based on an absence of biometric data for greater than a threshold amount of time (e.g., 1, 5, 10 minutes, etc.). If the sensor 211 comprises an accelerometer, then the wearable UE 210 may make a non-use determination based on a threshold low amount of motion (e.g., two or more planes having acceleration less than 0.5 meters/second) or a threshold low amount of motion variation (e.g., two or more planes having an acceleration within a threshold low range such as 0.1 m/s) for a predetermined amount of time. If the sensor 211 comprises a gyroscope, then the wearable UE 210 may make a non-use determination based on a threshold low amount of rotation or threshold low amount of rotation variation. If the sensor 211 comprises a light sensor, then the wearable UE 210 may make a non-use determination based on a threshold low amount of light or a threshold low variation of light. If the sensor 211 comprises a camera, then the wearable UE 210 may make a non-use determination based on a threshold low change in variation of a captured image. If the sensor 211 comprises a microphone, then the wearable UE 210 may make a non-use determination based on a threshold low amount of sound, a threshold low amount of sound variation. If the sensor 211 comprises an atmospheric sensor (e.g., temperature, pressure, humidity, water, etc.), then the wearable UE 210 may make a non-use determination based on a threshold low amount of observation variation for greater than a threshold amount of time (e.g., an observed pressure reading doesn't change more than hectopascal or one millibar for more than an hour).

Information from the radio 214 may be used to determine if the wearable UE 210 is not being used. The wearable UE 210, being configured to wirelessly communicate with other UEs or radio access networks, may determine whether a wireless connection is active or inactive or determine one or more connection parameters of said wireless connection. In a first example, the wearable UE 210 may utilize the radio 214 to determine that a connection to the first UE 204 is degrading, wherein both the wearable UE 204 and the first UE 204 are associated with the same user. In such an example, the wearable UE 210 may be connected to the first UE 204 using Bluetooth; if the signal strength degrades below a threshold (e.g., −70 dBm), then the wearable UE 210 may determine that it is not in use. In a second example, the wearable UE 210 may utilize the radio 214 to determine that its connection to the first UE 204 is sufficiently weak (or in active) for a threshold amount of time; that is, if a Bluetooth connection to the first UE 204 is inactive or too weak (e.g., less than −70 dBm) for greater than a threshold amount of time (e.g., more than five minutes), then the wearable UE 210 may determine it is not in use. In yet another example, the wearable UE 210 may utilize the radio 214 to determine that a connection parameter is degrading; that is, if the wearable UE 210 determines that a parameter (e.g., signal strength) of a wireless connection decreases greater than a threshold rate (e.g., greater than −10 dBm per minute), then the wearable UE 210 may determine it is not in use. In another example, the wearable UE 210 may utilize the radio 214 to determine that a connection to a network, router, or cell is active (when it perhaps should not be); that is, if the wearable UE 210 remains connected to a home Wi-Fi network when it should be accompanying a user to work or remains connected to a particular cellular base station global cell identity inconsistent with typical movement patterns, then the wearable UE 210 may determine it is not in use. In yet another example, connection information from the radio 214 may indicate that the wearable UE 210 is not connected to a network or device; if the wearable UE 210 is not connected to a vehicle or a public transit Wi-Fi network during a time it typically is (e.g., during a commute to school or work) or when the first UE 204 is, then the wearable UE 210 may determine it is not in use.

Information from the location module 215 may be used to determine if the wearable UE 210 is not being used. Using absolute location information, the wearable UE 210 may base a non-use determination on the wearable UE 210 having a location that diverges from a pattern (whether programmed or machine learned). For example, if the wearable UE 210 is typically worn 24 hours a day except when removed for a time period on weekday mornings (e.g., when the wearer is getting ready for work), then the wearable UE 210 may determine that it is non-use is sufficient to trigger a non-use indication based on a determination from the location module 215 that the wearable UE 210 has not departed the first location within a threshold amount of time of its typical departure time. Using relative location information, the wearable UE 210 may base a non-use determination on the wearable UE 210 having a location that is sufficiently different than another UE, such as the first UE 204 or the second UE 205. In one example, both the wearable UE 210 and the first UE 204 (e.g., in the form of a cell phone) may be associated with a common user. In such an example, the wearable UE 210 may receive location information of the first UE 204, whether via a direct connection or indirectly through a radio access network. Based on a determination that the wearable UE 210 has a location that is sufficiently distant from the first UE 204, the wearable UE 210 may determine the wearable UE 210 is not in use. Non-use determinations may also be made based on a combination of sufficient distance between the wearable UE 210 and the first UE 204 and a determination that the wearable UE 210 is not moving, or based on a determination that the wearable UE 210 and the first UE 204 are moving away from each other for at least a threshold amount of time. In aspects wherein the wearable UE 210 is specifically associated with a child or ward, then the wearable UE 210 may override a non-use determination based on information from the location module 215 that the wearable UE 210 is located within a threshold distance of the second UE 205, wherein the second UE 205 is associated with a parent or guardian of the child/ward.

Information from the power supply 216 may be used to determine if the wearable UE 210 is not being used. If the power supply 216 indicates that the wearable UE 210 is connected to an external power supply, then the wearable UE 210 may make a non-use determination based on it being charged/connected to external power.

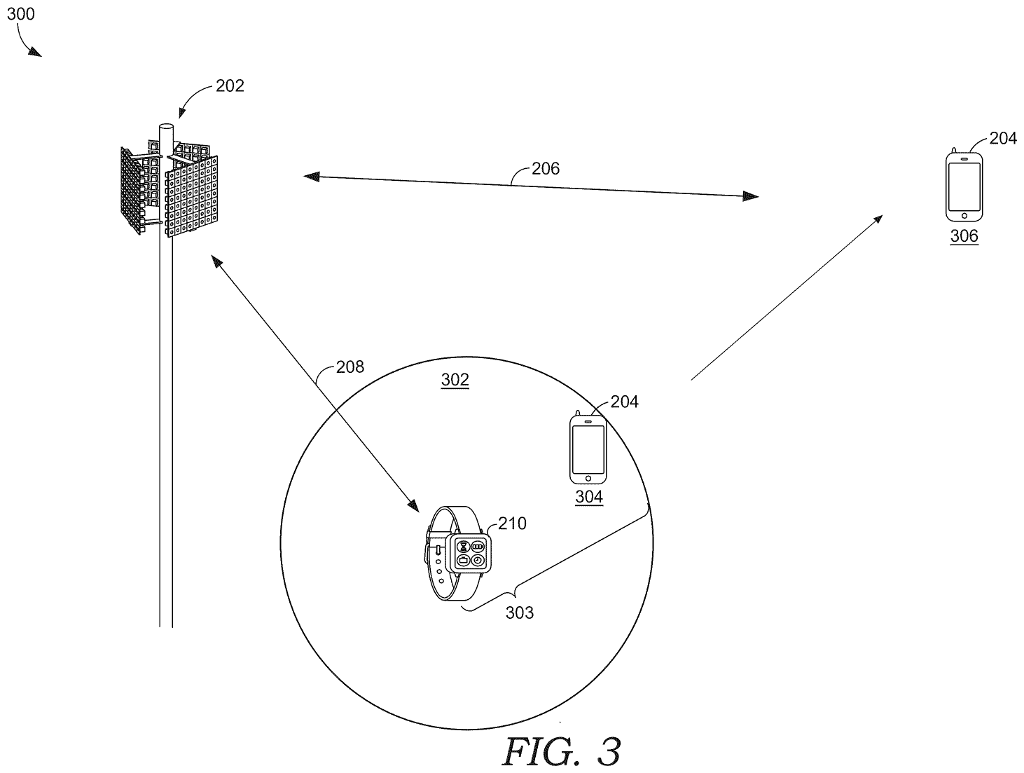

Turning now to FIG. 3, a hypothetical non-use scenario is illustrated in network environment 300. The network environment 300 comprises the base station 202, the wearable UE 210, the first UE 204, and wireless connections 206, 208 of FIG. 2. In the scenario illustrated by FIG. 3, the first UE 204 is moving from a first location 304, inside of an area 302 defined by range 303 of the wearable UE 210, to a second location 306, beyond the range 302 of the wearable UE 210. In aspects of the disclosure illustrated by the scenario of FIG. 3, a non-use determination may not be immediately made upon removal of the wearable UE 210; instead, the non-use determination may be made only after a movement condition has been met subsequent to the wearable UE 210 being de-coupled from the wearer. That is, if the wearable UE 210 is determined to be removed from the wearer and the first UE 204 (also being associated with the user of the wearable UE 204) is within the area 302, then the non-use determination will not be made. On the other hand, if the wearable UE 210 is determined to be removed from the wearer and the first UE 204 moves from inside the area 302 to outside the area 302, then a non-use determination may be made (subject, in some aspects, to the non-use diverging from a usage pattern). Determining whether the first UE 204 has left the area 302 is based on any one or more factors/conditions, including using the location module 215 of the wearable UE and location information of the first UE 204 to determine the location difference exceeds the range 303, observing a break (immediately or for greater than a hysteresis time) in a wireless connection between the wearable UE 210 and the first UE 204, observing a sufficiently worsening parameter (e.g., signal strength, signal quality, or SINR) of the connection between the wearable UE 210 and the first UE 204, detecting sustained motion at the first UE 204 without detecting motion sustained motion at the wearable UE 210, disconnection between a wireless network (e.g., a home Wi-Fi network) and the first UE 204 while the wearable UE 210 remains connected to the wireless network, and one or more handovers to a different cell by the first UE 204 without accompanying handovers by the wearable UE 210.

Returning to FIG. 2, the wearable UE 210 may utilize pattern divergence (whether programmed by a user or machine learned) in combination with any mechanism described herein in order to determine that the wearable UE 210 is not in use. When programmed (e.g., by a custodian), a usage pattern may comprise times and locations of use; for example, a parent may configure the usage pattern to indicate that the wearable UE 210 is expected to be worn during and proximate to the school day, such as from 8 am to 4 pm, and the location to be at school. In said example, a non-use determination may be made if the wearable UE 210 is removed at noon, but the non-use determination would not be made if the wearable UE 210 is removed at 10 pm. In other aspects, a machine-learned model may be used to create the usage pattern. After a training period, in which the machine-learned model observes use and non-use, the model may determine that the wearable UE 210 is typically worn approximately 23 hours a day and removed for approximately one hour on weekday mornings to charge (e.g., when the wearer is getting ready for work). Said machine-learned model may then equate a movement pattern with the usage pattern; for example, the movement pattern may comprise being in a first location (e.g., a home location) during the night hours, being doffed for a period of time, and then departing the home location (e.g., during a commute to work). Using this simple hypothetical, the wearable UE 210 may not make a non-use determination during the typically-doffed/charging time period, regardless of what the sensor(s) 211, radio 214, and/or location module 215 indicate. Using the same hypothetical, any one or more indications that the wearable UE 210 is not in use during the typically-worn time period may validate the non-use determination (e.g., lack of movement, connection to home network, connection to or observation of cell serving home location, connection to external power, lack of biometric information, and the like).

Particularly in embodiments where the wearable UE 210 is associated with a child or ward, the non-use determination may be made as soon as it is determined that the wearable UE 210 has been doffed (or as soon as it has been doffed for greater than a pre-determined amount of time).

The non-use determination may be based only on observations from the wearable UE 210 or may be based on an observational difference from an associated user device. In some aspects, each of the wearable UE 210 and the first UE 204 may report sensor, location, or radio information to a remote server, such as the cloud-based server 222—instead of or in addition to the wearable UE 210 making non-use determinations locally. Such a scheme may be helpful to reduce processing power required by the wearable UE 210 or to increase the accuracy of non-use determinations. Generally, if both the wearable UE 210 and the first UE 204 are associated with the first user, then differences in reported like-type observations may serve as the basis for or otherwise validate a non-use determination. For example, when the wearable UE 210 has been left behind in a quiet home and the first UE 204 is in car with music playing in the background on the way to work, then the cloud-based server 222 may receive audio measurements that are sufficiently different to determine that the wearable UE 210 and the first UE 204 are not in the same location. Any one or more sensor, radio, or location-based mechanisms described above may be suitable for use in this aspect, particularly radio-based mechanisms (connected to different cells or networks) and location-based mechanisms (the devices are moving further apart or one device leaves a geofenced area).

Based on a determination that the wearable UE 210 is not in use, one or more non-use indications may be provided to the wearable UE 210, the first UE 204, and/or the second UE 205. In aspects, the occurrence of a non-use indication may be configurable by a user or a parent/guardian of a user; for example, if the wearable UE 210 is associated with a child, then the parent (using the second UE 205) may configure non-use indications to be provided to the parent device (or any other parent-selected device) during certain times (e.g., school hours) and not to be provided during other times (e.g., at night). Non-use indications may utilize one or more different mechanisms, which may be provided on one or more of the wearable UE 210, the first UE 204 (associated with the same user as the wearable UE 210), and the second UE 205 (associated with a different user than the wearable UE 210). Examples of suitable non-use indications include the use of light emissions (activating/flashing a flashlight mode or GUI screen), audible emissions (music or tones), communications (e.g., SMS message, RCS message, automated phone call, or email), activation/manipulation of smart/connected devices (e.g., flashing a connected light bulb associated with the indication recipient, delivering a notification on other UEs or devices associated with the recipient subscriber (e.g., displaying a notification on an infotainment display of a connected vehicle associated with the indication recipient), engagement with a smart assistant (e.g., an announcement from the smart assistant that the device is not in use), and the like. Non-use indications may be handled locally in response to a non-use determination (e.g., the wearable UE 210 emitting audible tones as soon as it makes the non-use determination) or remotely (e.g., the wearable UE 210 reports its non-use determination to the cloud-based server 222 and the cloud-based server 222 delivers, communicates, or otherwise causes the non-use indication to be effectuated at the indication-recipient device. In aspects, the non-use indication may be provided or not provided based on a status of the first UE 204 or the second UE 205; that is, the wearable UE 210 may make a non-use determination and request information from another device before providing the non-use indication. In a first example, the wearable UE 210 may determine that it is not in use, request movement information from the first UE 204, receive an indication that the first UE 204 is also not presently in-use, and forego providing a non-use indication. In another example, the wearable UE 210 may determine that it is not in use, request movement/connection/audio information from the first UE 204, receive an indication that the first UE 204 is in a car (e.g., based on a connection between the second UE 205 in the form of a connected vehicle and the first UE 204), and then provide the non-use indication (e.g., on a display of the second UE 205 in the form of the connected vehicle).

Particularly when minimizing processing at the wearable UE 210 is desirable, the wearable UE 210 may provide indications to a recipient UE (i.e., the first UE 204 or the second UE 205) when the wearable UE 210 determines that it is not coupled to a user's body and allow the recipient UE to control the output of a non-use notification. In one non-limiting example, the recipient UE may have an application running thereon that processes non-use indications from the wearable UE 210; when the recipient UE receives the non-use indication from the wearable UE 210, it may execute logic to determine whether or not a notification should be output. Non-use indications provided to the recipient UE in such an embodiment could be instantaneously reactive (i.e., provided to the recipient UE immediately upon the wearable UE 210's non-use determination), delayed reactive (i.e., provided to the recipient UE some amount of time after the wearable UE 210's non-use determination, unless re-donned), or periodic (i.e., the wearable UE 210 periodically reports its use or non-use status to the recipient UE 210 at regular intervals). Determining whether or not to output a notification may then be based on observations or determinations at the recipient UE; for example, a notification may not be output if the recipient UE determines it is still connected to/paired with the wearable UE 210, whereas a notification may be output if the recipient UE determines a predetermined amount of time has elapsed or a pre-determined distance between the recipient UE and the wearable UE 210 has been exceeded.

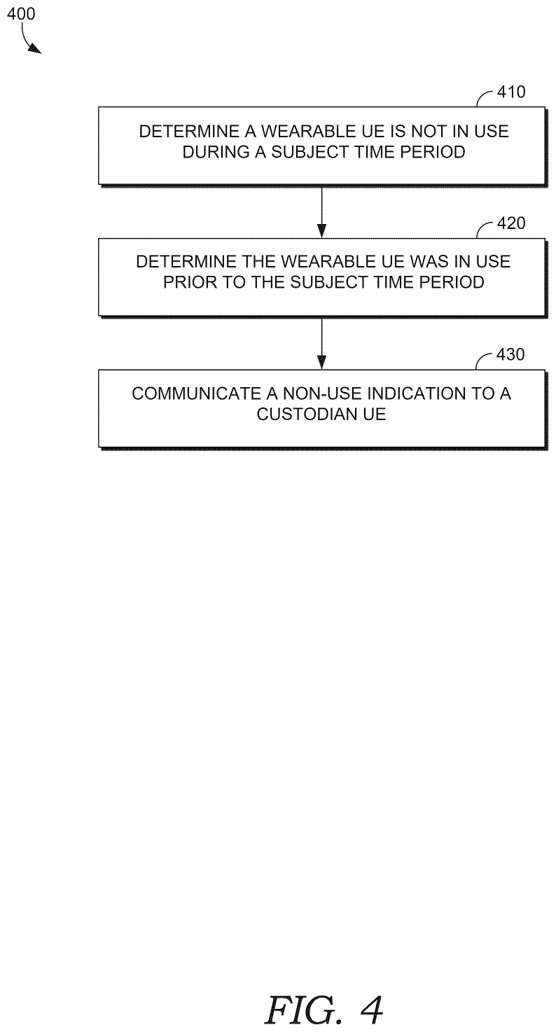

Turning now to FIG. 4, a flow chart representing a method 400 is provided. At a first step 410, it is determined that a wearable UE is not in use—or coupled to the body of a wearer—during a subject time period, according to any one or more aspects discussed herein. At a second step 420, it is determined that the wearable UE was in use or coupled to the body of the wearer prior to the subject time period—together indicating that the wearable UE has been de-coupled from the body of the wearer, according to any one or more aspects discussed herein. At a third step 430, a non-use indication is provided to a parent/guardian/custodial UE that indicates the wearable UE has been de-coupled from the body of a custodial (e.g., ward, child, elderly) user, according to any one or more aspects discussed herein. The third step 430 may, in some aspects, comprise determining that the wearable UE is associated with a user that has a parent/guardian.

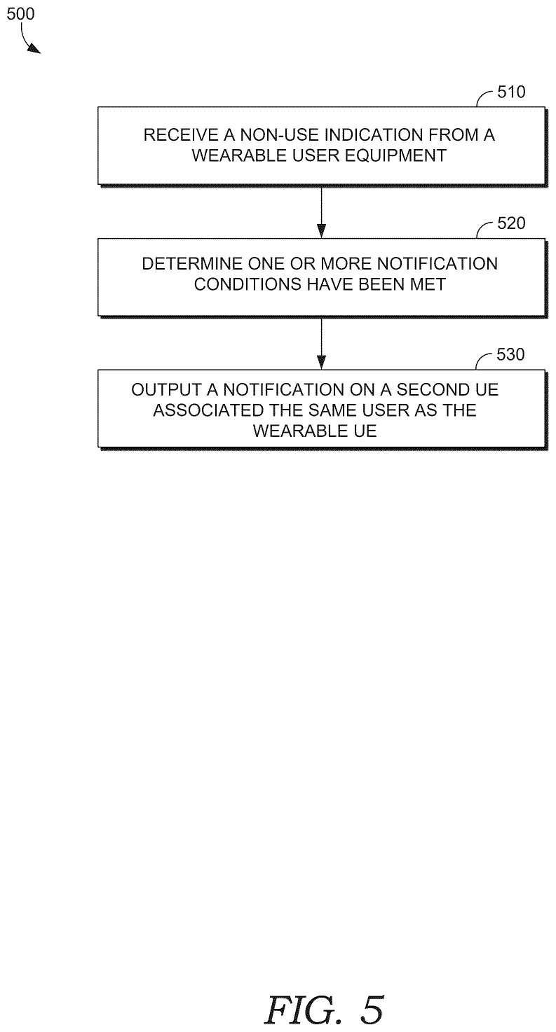

Turning now to FIG. 5, a flow chart representing a method 500 is provided. At a first step 510, a non-use indication is communicated from a wearable UE either to a networked component via a radio access network or directly to a paired/associated second UE, according to any one or more aspects discussed herein. At a second step 520, it is determined that one or more notification conditions have been met (e.g., divergence from a usage pattern, or a movement or location-based disparity between the wearable UE and the second UE), according to any one or more aspects discussed herein. In aspects where the method 500 is performed at a network component, the second step 520 may not be performed, or it may be performed at the wearable UE prior to communicating a non-use indication or at the second UE after the network communicates a non-use message to the second UE; rather, in such an embodiment, the second step 520 may comprise the network component identifying the second UE as being associated with the same user/subscriber as is associated with the wearable UE as a means for targeting delivery of a non-use message. When performed by the second UE, a notification is output by the second UE at a third step 530; when performed by networked components, the third step 530 comprises delivering the non-use message to the second UE, which causes the second UE to output a notification, according to any one or more aspects discussed herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for monitoring utilization of a wearable user equipment (UE), the system comprising:
one or more antenna elements configured to transmit and receive wireless communication signals with a station;
one or more sensors; and
one or more computer processing components configured to perform operations comprising:
determining, using information from one or more sensors of the wearable UE, that the wearable UE is not coupled to a user's body;
determining that one or more notification conditions have been met; and
providing a non-use indication to a second UE, the second UE being associated with the user.

2. The system of claim 1, the one or more sensors comprises a biometric sensor, the information from the one or more sensors comprises an indication that the wearable UE is not observing biometric conditions associated with the user during a subject time period.

3. The system of claim 2, wherein the biometric sensor comprises a capacitance sensor.

4. The system of claim 2, wherein the biometric sensor comprises a heartbeat sensor.

5. The system of claim 2, wherein the biometric sensor comprises a blood oxygen sensor.

6. The system of claim 2, wherein determining that one or more notification conditions have been met comprises determining that the second UE is moving and that the wearable UE is not moving.

7. The system of claim 6, wherein determining that one or more notification conditions have been met further comprises determining that the second UE has moved beyond a pre-determined range of the wearable UE.

8. The system of claim 2, wherein determining that one or more notification conditions have been met comprises determining that one or more parameters of a wireless connection between the wearable UE and the second UE are worse than at least one predetermined threshold.

9. The system of claim 2, wherein determining that one or more notification conditions have been met comprises determining the wearable UE is connected to a wireless access network and the second UE is not connected to the wireless access network.

10. The system of claim 2, wherein determining that one or more notification conditions have been met comprises determining that the subject time period is during a previously-determined usage time period during which the wearable UE is historically coupled to the user's body.

11. The system of claim 10, wherein the non-use indication provided to the second UE causes the second UE to output a first notification, the first notification being at least one of a graphic user interface visual element, operation of a flashlight feature of the second UE, and an audible tone.

12. The system of claim 11, wherein the operations further comprise providing a second non-use indication at the wearable UE that causes the wearable UE to emit an audible tone.

13. The system of claim 10, wherein the non-use indication provided to the second UE causes the second UE to output a first notification on a graphic user interface of an infotainment display, the second UE being a connected vehicle.

14. A method for monitoring utilization of a wearable user equipment (UE), the method comprising:
receiving an indication, via a radio access network, from a wearable UE that the wearable UE is not coupled to a user's body;
identifying a subscriber associated with the wearable UE;
identifying a second UE associated with the subscriber; and
providing a non-use indication to a second UE, via the radio access network, the second UE being associated with the user.

15. The method of claim 14, wherein the first UE is a watch and the second UE is a cellular phone.

16. The method of claim 15, wherein the non-use indication is provided to the second UE based on a determination that the wearable UE and the second UE are not attached to the same radio access network cell.

17. The method of claim 14, wherein the second UE is a connected vehicle and providing the non-use indication to the second UE is based on a determination that the second UE has attached to the radio access network within a predetermined amount of time of receiving the indication from the wearable UE.

18. A method for monitoring utilization of a wearable user equipment (UE), the method comprising:
receiving, at a second UE associated with a user, a non-use message from a radio access network, the non-use message indicating that the wearable UE is not coupled to the user's body, the wearable UE being associated with the user;
determining that one or more notification conditions have been met; and
outputting a notification on one or more interfaces of the second UE, the notification comprising one or more of displaying a visual element on a graphic user interface of the second UE, outputting an audible tone by the second UE, and operating a flashlight feature of the second UE.

19. The method of claim 18, wherein determining that one or more notification conditions have been met comprises determining that the non-use message is received during a previously-determined usage time period during which the wearable UE is historically coupled to the user's body.

20. The method of claim 18, wherein the non-use message comprises a location of the wearable UE, and determining that the one or more notification conditions have been met comprises determining that the location of the wearable UE is greater than a threshold distance from the second UE.
